(19) United States
(12) Patent Application Publication
(10) Pub. No.: US 2002/0174332 A1
(43) Pub. Date: Nov. 21, 2002

(54) Adaptive message authentication code

(75) Inventors: Jukka Vialen, Espoo (FI); Valtteri Niemi, Helsinki (FI)

Correspondence Address: ALTERA LAW GROUP, LLC, 6500 CITY WEST PARKWAY, SUITE 100, MINNEAPOLIS, MN, 55344-7704, US

(73) Assignee: Nokia Corporation, Espoo (FI)

(21) Appl. No.: 09/999,712

(22) Filed: Oct. 30, 2001

(30) Foreign Application Priority Data
Nov. 8, 2000 (FI) 20002453

(51) Int. Cl. H04L 9/00

(52) U.S. Cl. 713/152

(57) ABSTRACT

The invention allows transmission of a message in a single radio block when the length of the message with an added message authentication code exceeds the transmission block size. If the length of the message is shorter than the length of the block size, then the computed message authentication code is truncated to fit in the remaining space. Truncation is limited to a certain minimum value. At the receiving end a message authentication code is recomputed using exactly the same algorithm as was used at the transmitting end. Then the received message authentication code is compared with the recomputed authentication code. The bits of the truncated message authentication code are compared bit-by-bit to the bits of the recomputed authentication code. When the bits of the truncated message allocation code match the corresponding bits of the recomputed message allocation code, the received message is accepted.

### FIELD OF THE INVENTION

The present invention generally relates to a method for checking the integrity of messages between a mobile station and the cellular network.

### BACKGROUND OF THE INVENTION

All telecommunication is subject to the problem of how to make sure that the information received has been sent by an authorized sender and not by somebody who is trying to masquerade as the sender. The problem is particularly evident in cellular telecommunication systems, where the air interface presents an excellent platform for eavesdropping and replacing the contents of a transmission by using higher transmission levels, even from a distance. A basic solution to this problem is the authentication of the communicating parties. An authentication process aims to discover and check the identity of both the communicating parties, so that each party receives information about the identity of the other party and can rely on the identification to a sufficient degree. Authentication is typically performed in a specific procedure at the beginning of the connection. However, this does not adequately protect subsequent messages from unauthorized manipulation, insertion, and deletion. Thus, there is a need for the separate authentication of each transmitted message. The latter task can be carried out by appending a message authentication code (MAC-I) to the message at the transmitting end and checking the MAC-I value at the receiving end.

A MAC-I is typically a relatively short string of bits based in some specified way on the message it protects and on a secret key known both by the sender and by the recipient of the message. The secret key is generated and agreed on typically in connection with the authentication procedure at the beginning of the connection. In some cases the algorithm that is used to calculate the MAC-I based on the secret key and on the message is also secret, but this is not usually the case.

The process of authentication of single messages is often called integrity protection. To protect the integrity of signaling, the transmitting party computes a MAC-I value based on the message to be sent and the secret key using the specified algorithm, and sends the message with the MAC-I value. The receiving party recomputes a MAC-I value based on the message and the secret key according to the specified algorithm, and compares the received MAC-I and the calculated MAC-I. If the two MAC-I values match, the recipient can trust that the message is intact and has been sent by the authorized party. One may note in passing that integrity protection does not usually include protection of the confidentiality of the transmitted messages.

Integrity protection schemes are not completely reliable. A third party can try to manipulate and succeed in manipulating a message transmitted between a first and a second party. There are two main alternative methods for forging a MAC-I value for a modified or a new messages, namely by obtaining the secret key first or by trying directly without the secret key.

The secret key can be obtained by a third party basically in two ways:

by computing all possible keys until a key is found matching the data of observed message MAC-I pairs, or by otherwise breaking the algorithm for producing MAC-I values; or

by directly capturing a stored or transmitted secret key.

The original communicating parties can prevent a third party from obtaining the secret key by using an algorithm which is cryptographically strong and which uses a secret key long enough to prevent the exhaustive search of all keys, and by using other security means for the transmission and storage of secret keys.

A third party can try to disrupt the sending of messages between the two parties without a secret key basically by guessing the correct MAC-I value, or by replaying some earlier message transmitted between the two parties for which message the correct MAC-I is known from the original transmission.

Guessing of the correct MAC-I value can be prevented by using long MAC-I values. The MAC-I value should be long enough to reduce the probability of correct guessing to a sufficiently low level compared to the benefit gained by one successful forgery. For example, using a 32 bit MAC-I value reduces the probability of a correct guess to 1/4294967296, which is small enough for most applications.

Obtaining a correct MAC-I value using the replay attack, i.e. by replaying an earlier message, can be prevented by introducing a varying parameter to the calculation of the MAC-I values. For example, a time stamp value, a sequence number, or a random number can be used as further input to the MAC-I algorithm, in addition to the secret integrity key and the message. In the following, the prior art methods are described in more detail.

When using sequence numbers, each party has to keep track of which sequence numbers have already been used and are not acceptable any more. The easiest way to implement this is to store the highest sequence number used in MAC-I calculations so far. This approach has the drawback that between connections each party must maintain state information which is at least to some level synchronized. That is, they need to store the highest sequence number used so far. This requires the use of a large database in the network.

A further approach is to include a random number in each message, which the other side must use in MAC-I calculation the next time a message is sent for which MAC-I authentication is required. This approach has the same drawback as the previous one, i.e. between connections each party must maintain state information, which requires the use of a large database in the network.

FIG. 1 illustrates the computation of a message authentication code in the UTRAN (UMTS Terrestrial Radio Access Network), which is a wideband multiple access radio network currently being specified in the 3GPP (Third Generation Partnership Project). The length of the MAC-I used in UTRAN is 32 bits.

The UMTS integrity algorithm used in block 100 is a one-way cryptographic function for calculating the Message Authentication Code (MAC-I) based on the input parameters shown in FIG. 1. The one-way function means that it is impossible to derive the unknown input parameters from a MAC-I, even if all but one input parameter are known.

The input parameters for calculating the MAC-I are the actual signaling message (after encoding) to be sent, a secret integrity key, a serial number COUNT-I for the message to be integrity protected, a value indicating the direction of transmission, i.e. whether the message is sent in uplink or downlink direction, and a random number (FRESH) generated by the network. The computing block 100 calculates the message authentication code by applying the afore-mentioned parameters to the integrity algorithm, which is called f9 algorithm in 3GPP Release ′99 specifications.

FIG. 2 illustrates a message to be sent over e.g. a radio interface. The message is a layer N protocol data unit (PDU) 200, which is transferred as a payload in layer N-1 PDU 201. In the present example, layer N represents the Radio Resource Control (RRC) protocol in the radio interface and layer N-1 represents the Radio Link Control (RLC) layer. The layer N-1 PDU normally has a fixed size, which depends on the physical layer (the lowest layer, not visible in FIG. 2) channel type used and on the parameters, e.g. modulation, channel coding, interleaving. If layer N PDUs are not exactly the size of the payload offered by layer N-1 as is normally the case, layer N-1 can utilize functions like segmentation, concatenation, and padding to make layer N-1 PDUs always a fixed size. In the present application we are concentrating on a layer N PDU consisting of the actual signaling data and the Integrity Check Info. The Integrity Check Info consists of the MAC-I and the message sequence number SN needed at the peer end for the recalculation of MAC-I. The total length of the message is then a combination of the signaling bits and the Integrity Check Info bits.

FIG. 3 depicts actions to be carried out at the receiving end. The receiving end receives the message, step 300, including the signaling data part and the Integrity Check Info (which comprises the message sequence number SN and the 32-bit MAC-I). The signaling data together with the integrity key and the parameters, i.e. the COUNT-I (consisting of a hyper frame number HFN and the message sequence number SN), the direction of transmission, and the random number (FRESH), are processed in the computing block 301, for example a function like the UTRAN f9 function. with a fixed function. The computed message authentication code XMAC-I is then compared with the received message authentication code MAC-I received, step 302. If the said two codes match, the recipient can trust that the message is intact, and the recipient then accepts the message. Otherwise, the message is discarded, step 303.

The frame dependent COUNT-I number is actually the sum of a locally generated and incremented frame number HFN (Hyper Frame Number), which is added to the message sequence number, for example RRC_SN, and included in the message. The HFN is incremented each time SN reaches its maximum value (SN is normally very short, e.g. 4 bits).

Referring back to FIG. 2, it was mentioned previously that the transmitted block (layer N-1 PDU) normally has a fixed length. It may be that the signaling data bits together with the Integrity Check Info require more space than what is offered in one layer N-1 PDU payload. Actions to be performed in such a case will be explained in the following.

FIG. 4 illustrates the segmentation of a signaling message. Signaling message 400, which is too long to fit in a single layer N-1 block, is passed on to a lower layer, where it is split up into two blocks 401 and 402 (two layer N-1 PDUs), each with an appropriate layer N-1 header. Two blocks is just an example here, naturally a larger message may require even more than two blocks. Since the second layer N-1 PDU is not totally filled with the layer N data, padding bits are inserted. At the receiving end before transferring to a higher layer, the two layer N-1 payloads are reassembled into one layer N PDU. To a person skilled in the art, it is immediately obvious that the use of padding bits is a potential waste of resources.

TDMA systems, for example, have a limited radio block size, whereby a message including the full message authentication code does not necessarily fit into one radio block. This leads to the difficulty that the message has either to be sent without the MAC-I or in one or more additional segments.

In addition, there are certain time critical messages, for example, handover messages, which must be sent in one radio block only. Generally, segmentation is not desirable, because it wastes radio resources and slows down the signaling procedure unnecessarily.

One way to solve the above problem is to make the length of the message authentication code shorter than 32 bits. It has been proposed that such a message should include a field that defines the length of the message authentication code, a two-bit identifier, for example. This identifier allows certain discrete values: 8, 16, 24 and 32. This solution still has some problems. First, the identifier always takes two extra bits from the length of the message. Second, the discrete values are not flexible, and in some cases this can lead to the same problem as above, i.e. segmentation is needed for certain messages.

### SUMMARY OF THE INVENTION

An objective of the present invention is to devise a method that allows the transmission of a message in a single lower layer data block even when the length of the message including the Integrity Check Info exceeds the length of the lower layer data block.

The objective is achieved by computing, at the transmitting end, the message authentication code in the usual way in the system concerned and adding the MAC-I together with the message sequence number to the encoded message forming the actual PDU. Then the length of the message (without the Integrity Check Info) and/or the length of the PDU are examined as follows.

If the length of the message is longer than the length of the lower layer data block, the PDU is segmented into two or more data blocks as in prior art.

If the length of the PDU is shorter than the length of the lower layer data block, the PDU is placed into said lower layer data block and the rest of the block is filled with padding bits (normally by the lower layer itself).

But if the length of the PDU is longer than the length of the lower layer data block but the extra bits are less than the size of the MAC-I, then the computed message authentication code is truncated so that the truncated PDU fits into one layer N-1 data block. However, truncation of the message authentication code diminishes the security of the message exchange. Therefore, the number of bits the MAC-I is allowed to be truncated is limited to a certain maximum value, i.e. the truncated message authentication code has a certain minimum value.

Thereafter, the truncated PDU is sent via a radio interface to the receiving end.

At the receiving end the integrity is examined of the PDU received. First, the part including the signaling bits and the part including the Integrity Check Info are separated. Then a message authentication code is recomputed based on exactly the same algorithm and using the same parameters as were used at the transmitting end. The message authentication code of the received message is then compared with the recomputed authentication code.

In prior art systems the message received is immediately discarded if the message authentication codes received and recomputed do not match. But according to the present invention, if the receiving end finds that the message authentication code received is shorter than it should be, it assumes that the code has been truncated. Instead of n bits the truncated code comprises m bits. If the truncation exceeds the predetermined maximum amount known by the receiving end, the message is discarded.

If truncation does not exceed the predetermined maximum amount as known by the receiving end, the bits of the truncated message authentication code are compared bit-by-bit to the bits of the recomputed authentication code of full length. When the m bits of the truncated message authentication code match the corresponding bits of the recomputed message authentication code, the integrity check of the message received is passed.

On the one hand, it is true that truncation of the message authentication code diminishes the reliability of integrity protection. But on the other hand, the present invention makes it possible to transmit overlong messages in a single block while still sustaining acceptable security. The amount of truncation must be between zero and a certain maximum value. It can be envisaged that this maximum allowed amount of truncation can additionally vary for different types of messages according to system security requirements.

### BRIEF DESCRIPTION OF THE DRAWINGS

The invention will be described more closely with reference to the accompanying drawings, in which

FIG. 1 depicts the computation of a message authentication code;

FIG. 2 shows the contents of a message;

FIG. 3 illustrates the actions at the receiving end;

FIG. 4 depicts the creation of a message according to prior art;

FIG. 5 depicts the creation of a message according to the invention;

FIG. 6 is a flow chart showing the creation of a message in the GERAN system, and

FIG. 7 is a flow chart of actions at the receiving end.

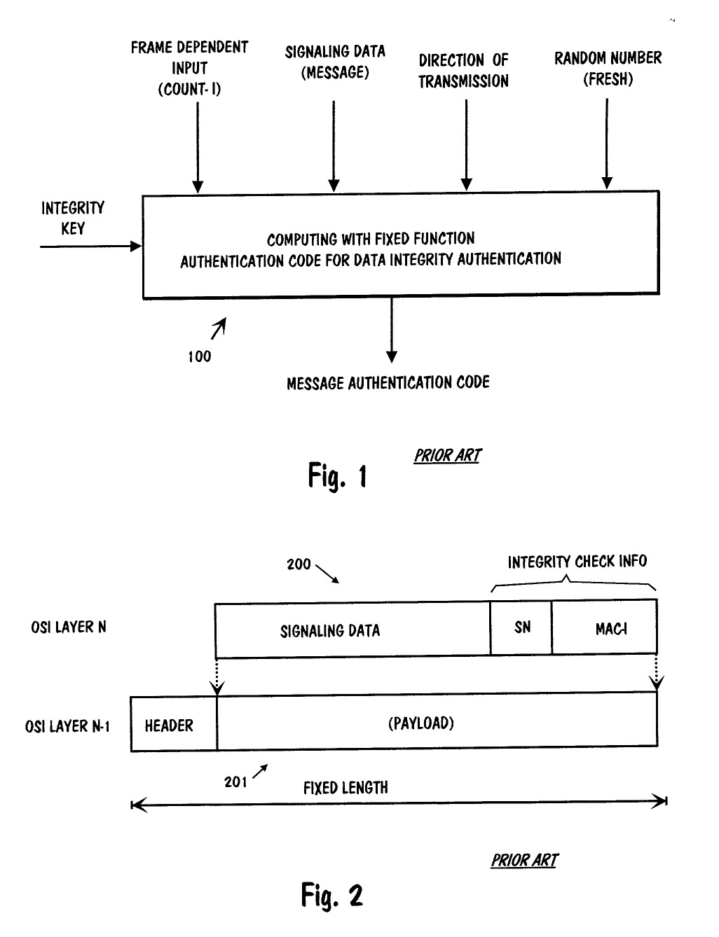

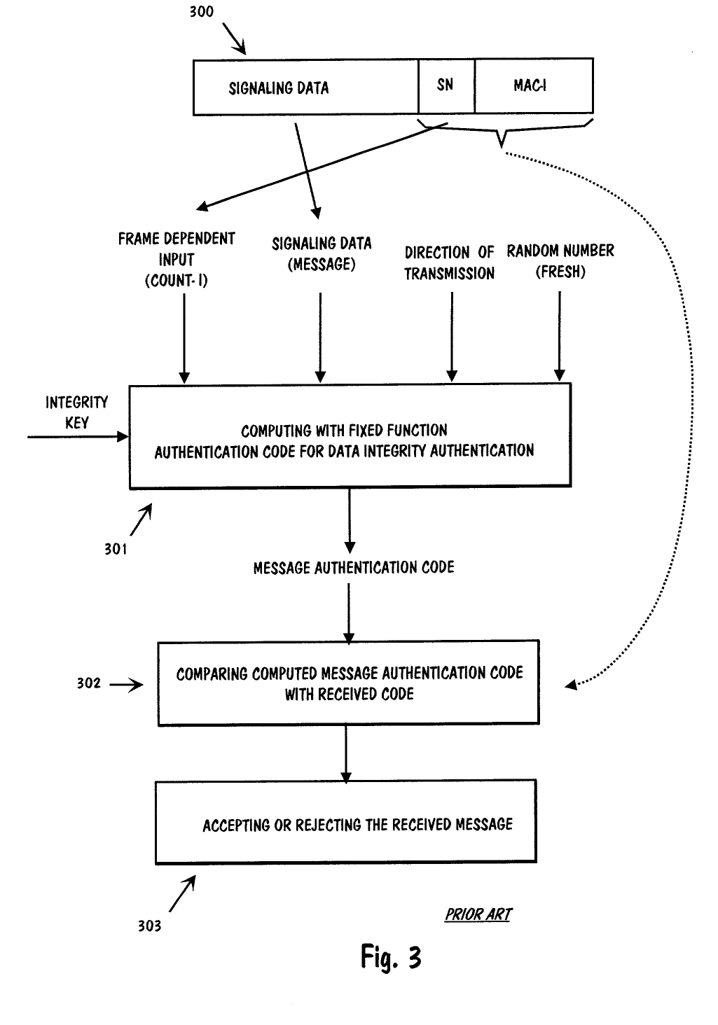

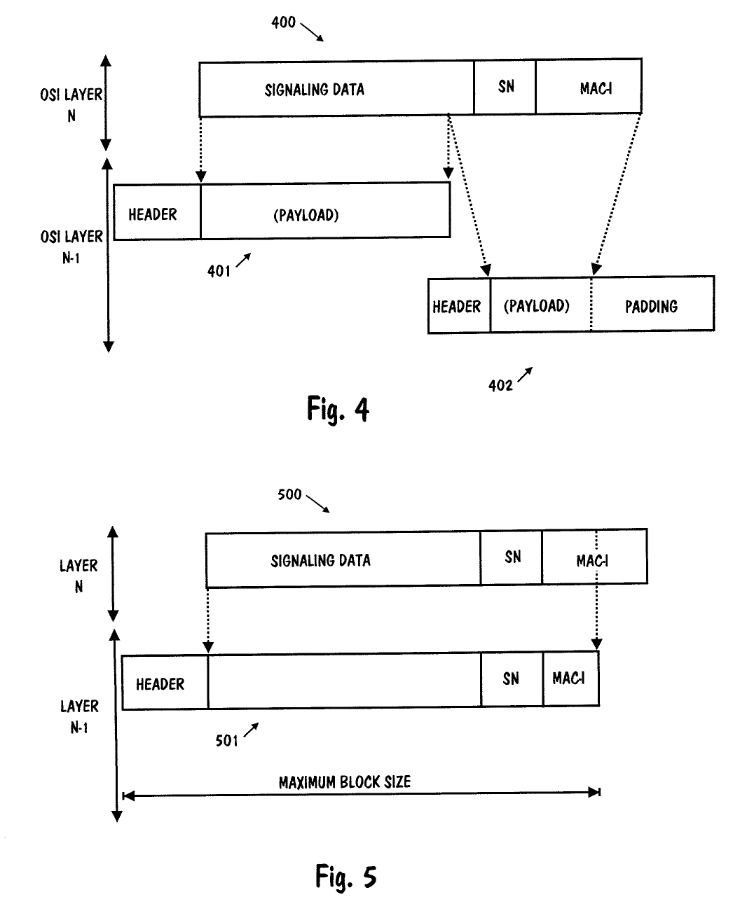

### DETAILED DESCRIPTION OF THE INVENTION

The invention will now be described in general terms.

FIG. 5 illustrates the situation where a signaling message 500 is to be sent in a secure manner over a lower layer radio link in one fixed length radio block, which can be a TDMA block, for example, without segmentation. The maximum block size allowed by the lower layer data block 501 is indicated by dotted lines in the figure. The signaling message without the Integrity Check Info (ICI) is in the illustrated situation shorter than the said maximum block size. This leads to a situation where the data to be sent either has to be segmented or sent without the message authentication code. Neither of these alternatives is acceptable.

In order for the data to be sent in a sufficiently secure manner over a radio link, the computed message authentication code should be appended to it. However, it must be shortened in a predefined way (described in detail below). This truncated message authentication code diminishes the reliability of the integrity protection to some degree but still provides sufficient protection for the message. It should be noted, that the sequential number SN needed to form the COUNT-I parameter cannot be truncated.

### PREFERRED EMBODIMENT OF THE INVENTION

GERAN is an evolution of the GSM-system (Global System for Mobile Communication), the TDMA/136-system (Time Division Access System), and the EDGE-system. GERAN has no integrity protection of its own.

Implementation of the same integrity algorithms used in UTRAN is suggested for a radio system using the GPRS/EDGE-radio connection network GERAN. This leads to certain significant problems, especially the problem of message segmentation.

To overcome the problem of message segmentation, a method where by an integrity algorithm can be used in the GERAN system is described in the following. The implementation of the invention is examined with the help of some examples.

Prior to that, radio interface protocols are considered briefly in the following.

Radio interface protocols are needed to set up, reconfigure, and release the Radio Bearer services. The protocol layers above the physical layer are called the data link layer (layer 2) and the network layer (layer 3). The control plane layer 2 contains two sub-layers: Medium Access Control (MAC) protocol and Radio Link Control (RLC) protocol. Layer 3 consists of one protocol, called Radio Recourse Control (RRC), which belongs to the control plane. The channels offered by the physical layer to the MAC layer are called logical channels.

All higher layer signaling (mobility management, call control, session management, etc.) is encapsulated into RRC messages for transmission over the radio interface.

The following provides a description of integrity protection for a message to be sent over a radio link. The invention is described in detail first from the point of view of the transmitting end and then from the point of view of the receiving end.

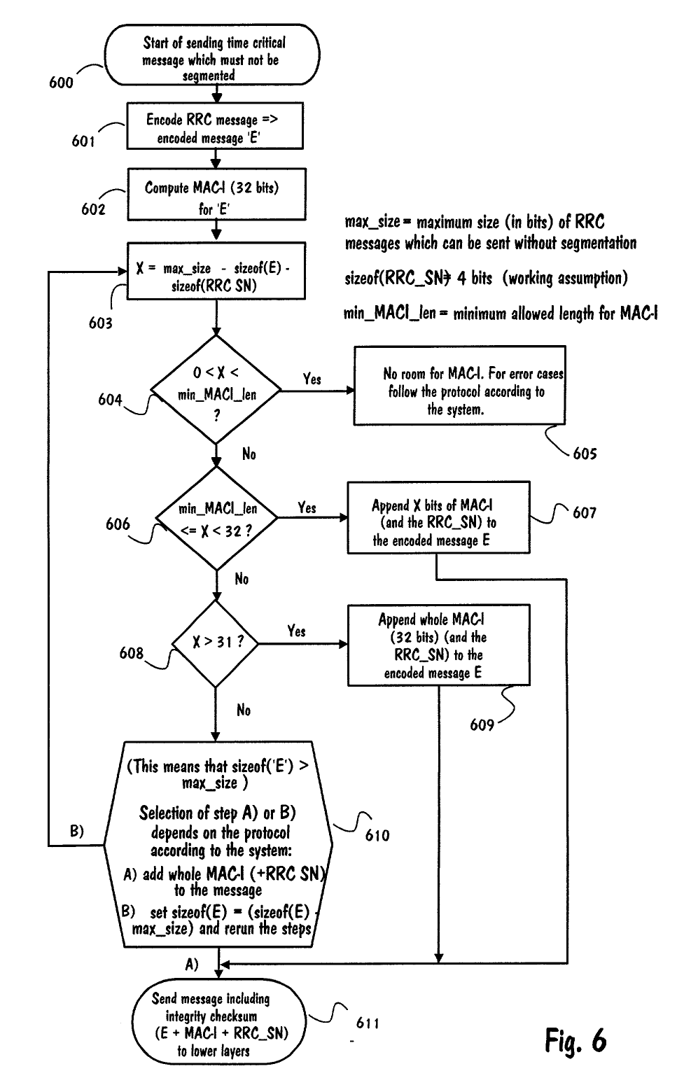

FIG. 6 shows as a flowchart an example of one implementation of the method according to the invention from the point of view of the transmitting end.

At stage 600 a time critical RRC message is to be sent through a radio interface, for example from the network to a mobile.

Most signaling messages sent between a mobile station MS and the network, for example, must be integrity protected. Examples of such messages are RRC, MM, CC, GMM, and SM messages. Integrity protection is applied at the RRC layer, both in the mobile station and in the network.

Integrity protection is usually performed for all RRC (Radio Recourse Control) messages, with some exceptions. These exceptions can be:

messages that are assigned to more than one recipient,

messages that have been sent before integrity keys were created for the connection,

frequently repeated messages, including information which does not need integrity protection.

The message is encoded according to the specified message transfer syntax at stage 601. The encoded message (bit string) is called here E.

A 32-bit message authentication code MAC-I, which is to be added to the encoded message, is calculated at stage 602.

The message authentication code not only depend on the encoded message but also on several other parameters. The following input parameters are needed for calculation of the integrity algorithm: the encoded message, the 4-bit sequence number SN, the 28-bit hyper-frame number HFN, the 32-bit random number FRESH, the 1-bit direction identifier DIR, and the most important parameter—the 128-bit integrity key IK. The short sequence number SN and the long sequence number HFN together compose the serial integrity sequence number COUNT-I.

When the message authentication code is computed using the UMTS integrity algorithm and the above parameters, it is guaranteed that no one other than the actual sender can add the correct MAC-I code to the signaling message. COUNT-I, for example, prevents the same message from being sent repeatedly. However, if the same signaling message for some reason or other is to be sent repeatedly, the MAC-I code differs from the MAC-I code that was in the previously sent signaling message. The aim of that is to protect the message as strongly as possible against eavesdroppers and other fraudulent users.

Due to the fact that a TDMA radio block has a fixed length, the length of the message has to be checked to avoid segmentation of the message. The RRC layer makes a decision as to whether the segmentation of the message concerned is to be allowed or not.

At stage 603 the total length of the signaling message to be sent without the message authentication code is calculated using the following formula:

X =Max_size−sizeof(E)−sizeof(RRC_{—SN)}

In the above formula max_size is the maximum size (in bits) of a RRC message that can be sent in one radio block (i.e. there is no need for segmentation). Sizeof(E) is the size (in bits) of the encoded message and sizeof(RRC_SN) is the size of the RRC sequence number, a 4-bit working assumption. X defines the length (in bits) of the rest of the fixed length message, which is still left after the minimum number of bits are reserved for the message authentication code, the untruncated MAC-I size may be different.

Next, at stage 604, a comparison is made to ascertain whether the calculated X is between values 0 and min_MACI_len, where the latter value is the minimum allowed length for the message authentication code. This minimum length is a predefined value, which can be either the same for all messages or even a message type specific value. It is clear that the smaller the value, the weaker the protection. So it is obvious that a minimum length must be determined so that the message can be sent with adequate security.

If the answer after said comparison is YES, this means that the message authentication code does not fit with the signaling message to be sent in one radio block. In other words, the space left in one radio block is too short even for a shortened message authentication code after the signaling message is put into the block. If this is the case, the system protocol defines 605 as the next action to be carried out.

If the answer after comparison is NO, the next step is to compare whether X is between values min_MACI_len and 32, stage 606.

If X is between those values, i.e. if the answer after the comparison in stage 604 is YES, then X bits of the message authentication code with the RRC_SN are added to the encoded message, stage 607. The sequence number RRC5_SN is needed for integrity protection, that is, for calculation of the message authentication code at the receiving end. Note that the MAC-I size is also 32 bits in the UTRAN system. In some other systems, the ′normal′ MAC-I size may be something different.

The length of the message authentication code is shortened in a predefined way. Thus, the size of the message authentication code transmitted over the radio path depends dynamically on the size of each encoded message, not on the type of the message.

The decisions are made at the RRC layer as to the minimum message authentication code size and as to when the size of the said code may be shortened. In some cases the RRC layer can make the decision that the message authentication code is not to be shortened even though this would have been possible. Such cases might occur when strong protection is demanded for a message.

The next step 611 is to send the message including the integrity protection info (E+MAC-I+RRC_SN) to the lower layers for transmission over the radio interface to the mobile station.

If the answer in the above comparison 604 is NO, a final comparison is made as to whether the value of X is greater than 31, stage 608. If the answer is YES, this means that neither shortening nor segmentation is needed. Now the whole message authentication code and the RRC_SN are appended to the encoded message E, stage 609. The next step is stage 611.

If the answer to the comparison at stage 608 is NO, i.e. if X is smaller than 0, which means that the size of the encoded message sizeof(E) is greater than the maximum size of the RRC message max_size, then two different alternatives A and B, are possible at stage 610:

A) add the entire MAC-I (+RRC_SN) to the message;

B) set sizeof(E)=(sizeof(E)−max_size) and rerun the previous steps.

Which of the two above alternatives is selected depends on the protocol according to the system.

Alternative A means that the whole message authentication code with the sequence number RRC_SN is added to the block, since the message has to be segmented anyway. Thus with this alternative, it is not important whether adding Integrity Protection Info causes additional segmentation or not.

In alternative B, the attempt is made to avoid the additional segmentation caused by the addition of Integrity Check Info. Thus the sizeof(E) is set one full data block shorter than what was given in stage 601, and the truncation algorithm for the MAC-I is rerun starting from step 603.

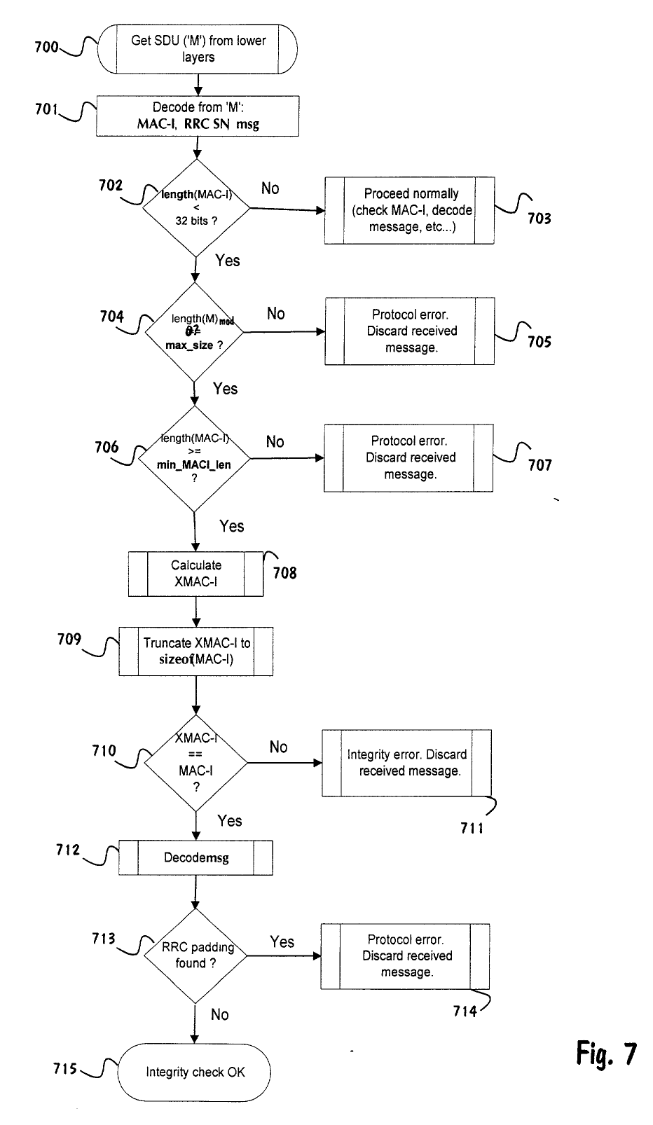

FIG. 7 shows as a flowchart an example of one implementation of the method according to the invention from the point of view of the receiving end.

At stage 700 the receiving end gets a Service Data Unit (SDU) comprising the signaling data M from the lower layers. It is assumed here that this message is the same as in the previous example in FIG. 6. The next step is that the part including signaling data bits and the part including the Integrity Check Info MAC-I (the message authentication code with the sequence number the RRC-SN) are separated and a message authentication code with RRC sequence number RRC_SN is decoded in stage 701. The actual message (signaling data) can still be stored as an encoded bit string at this point.

In prior art systems the message received is discarded immediately if the received and the recomputed message authentication codes do not match. But according to the invention, the receiving end first examines the length of the message authentication code and, depending on the result, it then decides, if and how the message is to be processed further.

Thereafter the length of the message authentication code of the message received is examined at stages 702 and 706. In addition, the length of the entire message (including the signaling data and the integrity check info) received is also examined at stage 704.

At stage 702 a check is made as to whether the length of the MAC-I is ′normal′, in this example 32 bits. If YES (the answer to stage 702 is NO), the flow proceeds to stage 703, where the message is processed in the normal way. The message authentication code is checked, the message is decoded, etc. using the same algorithm and parameters as were used at the transmitting end.

Provided that stage 702 yields the YES alternative, meaning that the MAC-I has been truncated, a check is made as to whether the length of the message is a multiple of the max_size (sizeof(M) mod max_size ==0), justifying the MAC-I truncation. A NO alternative yields a protocol error, for which reason the message received is discarded 705.

A YES answer after stage 704 leads to stage 706, when a comparison is made as to whether the length of the message authentication code is greater than or equal to the minimum allowed MAC-I length (min_MACI_len). A NO alternative yields a protocol error, for which reason the received message is discarded 707. If the length is greater than or equal to the minimum value, the transmitting end may have shortened the MAC-I code in the correct way. With the integrity key and all the other needed parameters, the expected message authentication code XMAC-l is calculated 708, using the same algorithm as for the transmitting end. The calculated XMAC-I has to be truncated in order to compare its size with the size of the transmitted MAC-I, stage 709. If the truncated XMAC-I does not correspond to the transmitted truncated MAC-I 710, an integrity error is found and the received message is discarded 711. If the result of the comparison is positive, the message is decoded 712. The final check 713 is made after decoding the actual signaling data 712. The final check is to find out whether there are some padding bits in the received message. Since the MAC-I has been truncated due to message size, no padding bits are allowed (since the padding bits should have been used for the MAC-I). The Integrity check is OK whenever no RRC padding bits are found 713, i.e. it is then ensured that the message has been sent from the authorized party 715. Otherwise, a protocol error is found and the message is discarded, stage 714.

An implementation and embodiment of the present invention has been explained above with some examples. However, it is understood that the invention is not restricted to the details of the above embodiment and that numerous changes and modifications can be made by those skilled in the art without departing from the characteristic features of the invention. The embodiment described is to be considered illustrative but not restrictive. Therefore, the invention should be limited only by the attached claims. Thus, alternative implementations defined by the claims, as well as equivalent implementations, are included in the scope of the invention.

For example, instead of at the RRC layer the decision concerning the MAC-I size can be made at some other layer, e.g. the RLC layer. In that case, the RLC must know whether segmentation of the message(s) in the transmission buffer is to be allowed or not.

The protocol layers from top to bottom are; RRC, LLC (Logical Link Control), LAPDm (Link Access Protocol on the Dm channel), PDCP (Packet Data Convergence Protocol), RLC, MAC (Medium Access Control Protocol), and PHY (Physical Layer) In addition, the minimum value, which is set at min_MACI_len might also depend on the signaling message used. The grouping of signaling messages into different min_MACI_len categories can be carried out either simply according to the message type. Grouping can be based on other factors aas well, such as on whether the message is so that for critical signaling messages the value is greater than for non-critical signaling messages. For some non-critical messages the min_MACI_len could be set as low as 8 bits, for example.

It should also be noted that although this application is made only from the signaling standpoint, integrity protection can also be applied in some systems to the user plane data. The same principles and methods described in this application are applicable also for user plane data packets, although the actual protocol layers performing the integrity protection, and the message authentication code truncation would then be different.

1. A method of transmitting a message through a transmission channel in at least one data block, the data block having a fixed length and comprising payload bits and data integrity information bits including at least a message authentication code, comprising:
at the transmitting end,
computing with a predetermined function the message authentication code having a fixed length;
checking the total number of the payload bits and the data integrity information bits;
truncating the message authentication code the total number being in excess of the fixed length of the data block and the excess being less than the fixed length of the message authentication code;
placing the payload bits to the data block;
placing the data integrity information bits including the truncated message authentication code to the data block,
sending the data block, and
at the receiving end,
extracting the truncated message authentication code from the data block received;
recomputing, with the predetermined function, a message authentication code having the fixed length;
comparing the truncated message authentication code with the recomputed message authentication code;
accepting the message when the bits of the truncated message authentication code match the corresponding bits of the recomputed message authentication code.

2. A method as in claim 1, wherein the length of the truncated message authentication code has a predetermined minimum value.

3. A method as in claim 2, wherein the assembling of the data block ceases when the length of the truncated message authentication code is shorter than the predetermined minimum value.

4. A method as in claim 2, wherein the payload bits are segmented for at least two subsequent data blocks when the length of the truncated message authentication code is shorter than the predetermined minimum value, wherein the message authentication code in the last data block is truncated.

5. A method as in claim 1 or 2, comprising the further steps at the receiving end of:
checking the length of the message authentication code of the data block received;
discarding the message received when the length is shorter than the predetermined minimum value.

6. A method as in claim 2, comprising the further steps at the receiving end of:
checking the length of the message authentication code of the data block received;
truncating the recomputed message authentication code to the same length as the length of the message authentication code received;
comparing the message authentication code received with the truncated recomputed message authentication code.

7. A method as in claim 6, comprising of the further steps of:
decoding the message;
determining the existence of padding bits in the decoded message;
discarding the message received when padding bits are found.

8. A system comprising a transmitting element and a transmission channel, wherein a message is transmitted in at least one data block to the transmission channel, the data block having a fixed length and comprising payload bits and data integrity information bits including at least a message authentication code, the transmitting element comprising
means for computing with a predetermined function the message authentication code having a fixed length;
means for truncating the message authentication code when the total number of the payload bits and the data integrity information bits exceeds the fixed length of the data block and the excess is less than the fixed length of the message authentication code;
means for placing the payload bits and the data information bits including the truncated authentication code into the data block, and
means for sending the data block to the transmission channel.

9. A system as in claim 8, further comprising a receiving element, the receiving element comprising:
means for receiving the data block from the transmission channel;
means for extracting the truncated message authentication code from the data block received from the transmission channel;
means for recomputing, with the predetermined function, a message authentication code having the fixed length;
means for comparing the truncated message authentication code with the recomputed message authentication code; and
means for accepting the message when the bits of the truncated message authentication code match the corresponding bits of the recomputed message authentication code.

10. A system as in claim 8, further comprising:
means for checking the length of the message authentication code of the data block received;
means for truncating the recomputed message authentication code to the same length as the length of the message authentication code received; and
means for comparing the message authentication code received with the truncated recomputed message authentication code.
